(19) United States
(12) Patent Application Publication
(10) Pub. No.: US 2013/0110807 A1
(43) Pub. Date: May 2, 2013

(54) INTRANET SEARCH, SEARCH ENGINE AND TERMINAL EQUIPMENT

(71) Applicant: International Business Machines Corporation, Armonk, NY (US)

(72) Inventors: Sheng Hua Bao, Beijing (CN); Yuan Ni, Shang Hai (CN); Haichuan Wang, Beijing (CN); Hui Jia Zhu, Shanghai (CN)

(73) Assignee: International Business Machines Corporation, Armonk, NY (US)

(21) Appl. No.: 13/662,585

(22) Filed: Oct. 29, 2012

(30) Foreign Application Priority Data
Oct. 31, 2011 (CN) 201110347170.3

(51) Int. Cl. G06F 17/30

(52) U.S. Cl. 707/706; 707/E17.108; 707/E17.032

(57) ABSTRACT

A method and apparatus for searching an enterprise intranet. An intranet search method includes receiving an intranet inquiry; and in response to the intranet inquiry, returning as a part of search results, a link matching the intranet inquiry in an email in an email system. An embodiment of the invention improves the performance of the intranet search engine such that it can better satisfy the employees' need.

### CROSS-REFERENCE TO RELATED APPLICATION

This application claims priority under 35 U.S.C. §119 from Chinese Patent Application No. 201110347170.3 filed Oct. 31, 2011, the entire contents of which are incorporated herein by reference.

### BACKGROUND OF THE INVENTION

1. Technical Field

The invention generally relates to intranet, and more specifically to an intranet search method and apparatus, a search engine and terminal equipment.

2. Description of the Related Art

Internet search techniques are relatively well known, but search of an enterprise intranet is developing very slowly. Employees of enterprises complain that finding desired information through the enterprise intranet is difficult and time-consuming.

Presently, the common technique in enterprise intranet search is migrating Internet search techniques to the enterprise intranet. However, a problem occurs from such a migration, that is, due to features such as isolated data sources of the intranet, relatively decentralized search, slow updates of information, Internet search techniques cannot be completely adapted.

Another technique in enterprise intranet search is an intranet search engine specially developed for enterprises. FIG. 1 is a schematic diagram showing an intranet search engine in the prior art and its external environment. As shown in FIG. 1, an intranet search engine 201 installed on a terminal equipment 212 includes a search engine front-end 202, a search buffer 205, and an intranet crawler 208. The intranet crawler 208 searches new links on an enterprise intranet 216 periodically and stores the searched new links in the search buffer 205. Since the search is periodical, by setting a period of search, information stored in the search buffer 205 essentially reflects all the links capable of being found by the enterprise intranet 216 at present. A receiving unit 203 in the search engine front-end 202 receives from a terminal user 204 an inquiry with a keyword. Links matching the keyword are searched in the search buffer 205 according to the keyword, as search result to be fed back to the terminal user 204.

A problem existing in the intranet search engine in the prior art is that, the performance cannot satisfy the needs of the employees. It is reflected in the following aspects:

Data sources of the enterprise intranet are isolated from each other. Different departments of the enterprise can have different sub-webpages containing various links, and the sub-webpages are not necessarily always linked to the home page of the enterprise. When the intranet crawler 208 searches the enterprise intranet 216 for information, it is possible that links associated with some information are not linked to the enterprise intranet 216. If the information is what the employees exactly needed, it is difficult for the employees to find it.

Since searches of the employees are relatively decentralized, it is hard to make statistics of a hot degree of the keywords. Therefore, many enterprise intranets do not sort the search results. Even if sorting is made, authority of the sorting is poor. Because the enterprise intranet is updated slowly, a lot of information is out of date, which has an impact on search effects. There are some independent data sources in the enterprise that are not linked to the intranet, so intranet search apparently can do nothing about the data sources. Furthermore, information security issues of the enterprise also hamper sharing of partial information.

### SUMMARY OF THE INVENTION

According to an aspect of the invention, an intranet search method is provided. The method includes receiving an intranet inquiry, and in response to the intranet inquiry, returning as a part of search result, a link matching the intranet inquiry in an email in an email system.

According to a second aspect of the invention, an intranet search apparatus is provided. The apparatus includes a receiving unit configured to receive an intranet inquiry; and an inquiry result generating unit configured to, in response to the intranet inquiry, return as a part of search result, a link matching the intranet inquiry in an email in an email system.

According to a third aspect of the invention, computer readable storage medium tangibly embodying a computer readable program code having computer readable instructions which, when implemented, cause a computer to carry out the steps of a method. The method includes receiving an intranet inquiry, and in response to the intranet inquiry, returning, as a part of search results, a link matching the intranet inquiry in an email in an email system.

### BRIEF DESCRIPTION OF THE DRAWINGS

The accompanying drawings to which the present application makes reference are only used for exemplifying typical embodiments of the invention, but shall not be construed as limiting the scope of the invention.

FIG. 1 is a schematic diagram showing an intranet search engine in the prior art and its external environment.

FIG. 2 is a block diagram showing an exemplary computer system which is applicable to implement the embodiments of the present invention

FIG. 3 is a schematic diagram showing an intranet search engine according to an embodiment of the invention and its external environment.

FIG. 4 is a block diagram showing an intranet search apparatus according to an embodiment of the invention.

FIG. 5 is a schematic diagram showing an intranet search engine according to another embodiment of the invention and its external environment.

FIG. 6 is a flow chart showing an intranet search method according to an embodiment of the invention.

### DETAILED DESCRIPTION OF THE PREFERRED EMBODIMENT

In the followings discussion, details are provided to help thoroughly understand the present invention. However, it is apparent to those of ordinary skill in the art that even though there are no such concrete details, the understanding of the present invention cannot be influenced. It should be further appreciated that any specific terms used below are only for the convenience of description, and the present invention should not be limited to only use in any specific applications represented and/or implied by such terms.

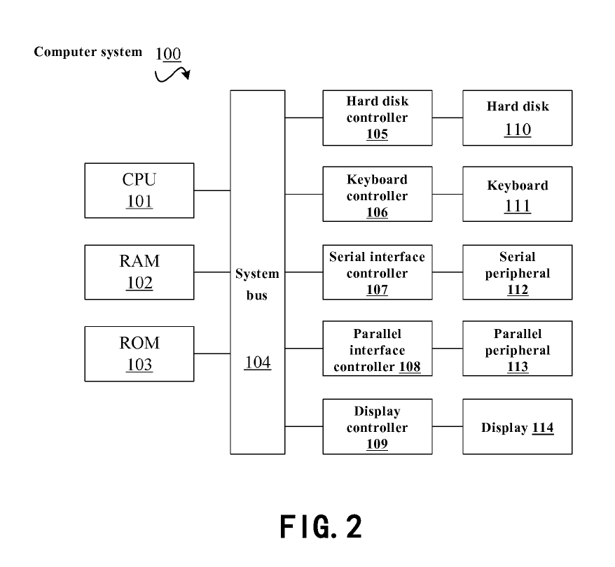

FIG. 2 shows an exemplary computer system 100 which is applicable to implement the embodiments of the present invention. As shown in FIG. 2, the computer system 100 can include: CPU (Central Process Unit) 101, RAM (Random Access Memory) 102, ROM (Read Only Memory) 103, System Bus 104, Hard Drive Controller 105, Keyboard Controller 106, Serial Interface Controller 107, Parallel Interface Controller 108, Display Controller 109, Hard Drive 110, Keyboard 111, Serial Peripheral Equipment 112, Parallel Peripheral Equipment 113 and Display 114. Among above devices, CPU 101, RAM 102, ROM 103, Hard Drive Controller 105, Keyboard Controller 106, Serial Interface Controller 107, Parallel Interface Controller 108 and Display Controller 109 are coupled to the System Bus 104. Hard Drive 110 is coupled to Hard Drive Controller 105. Keyboard 111 is coupled to Keyboard Controller 106. Serial Peripheral Equipment 112 is coupled to Serial Interface Controller 107. Parallel Peripheral Equipment 113 is coupled to Parallel Interface Controller 108. And, Display 114 is coupled to Display Controller 109. It should be understood that the structure as shown in FIG. 2 is only for the exemplary purpose rather than any limitation to the present invention. In some cases, some devices can be added to or removed from the computer system 100 based on specific situations.

As will be appreciated by one skilled in the art, aspects of the present invention can be embodied as a system, method or computer program product. Accordingly, aspects of the present invention can take the form of an entirely hardware embodiment, an entirely software embodiment (including firmware, resident software, micro-code, etc.) or an embodiment combining software and hardware aspects that can all generally be referred to herein as a “circuit,” “module” or “system.” Furthermore, aspects of the present invention can take the form of a computer program product embodied in one or more computer readable medium(s) having computer readable program code embodied thereon.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium can include the followings: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

A computer readable signal medium can include a propagated data signal with computer readable program code embodied therein, for example, in baseband or as part of a carrier wave. Such a propagated signal can take any of a variety of forms, including, but not limited to, electro-magnetic, optical, or any suitable combination thereof. A computer readable signal medium can be any computer readable medium that is not a computer readable storage medium and that can communicate, propagate, or transport a program for use by or in connection with an instruction execution system, apparatus, or device.

Program code embodied on a computer readable medium can be transmitted using any appropriate medium, including but not limited to wireless, wireline, optical fiber cable, RF, etc., or any suitable combination of the foregoing.

Computer program code for carrying out operations for aspects of the present invention can be written in any combination of one or more programming languages, including an object oriented programming language such as Java, Smalltalk, C++ or the like and conventional procedural programming languages, such as the “C” programming language or similar programming languages. The program code can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions can also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

A core idea of the invention is that the email system in an enterprise is a data source relatively independent of the intranet. The email system of the enterprise contains a great deal of useful data source information. For example, in order to fill in a year-end sum up, employees need to find an entry to the page for filling in a year-end sum up, but no useful results can be found through the intranet search engine in the prior art (e.g., the link at the time is possibly not linked to the intranet by a relevant department responsible for maintaining it). However, in fact, in an email sent to the employee by his superior, there is a link to the page for filling in a year-end sum up, and an absolute deadline before which the year-end sum up must be submitted is clearly indicated in the email. If the intranet search engine of the enterprise can refer to the information in the email system, search effects can be greatly improved.

The intranet search engine according to an embodiment of the invention periodically searches the email system while periodically collecting updated data from the enterprise intranet, and also stores the links appearing in the emails in the email system. In addition, since the links appearing in the email system are even more important than the results searched on the enterprise intranet, a higher score can be given to the links appearing in the emails while sorting the search results such that the links are sorted in front while being presented to the search user.

The invention achieves an effect, that is, even if some important links needed by the employees are not linked to the intranet possibly due to isolated data sources of different departments, they can be obtained through searching the email system, because emails are usually broadcast cross a number of departments. Since the email system possibly further contains links to other data sources of non-intranets, data sources of the search engine are expanded.

Since the obtained email in the email system contains time information, timeliness can be taken into consideration while sorting the search results, thereby solving the problem that out-of-date information has an impact on searching efficiency. In addition, since emails contain a great deal of up-to-date information, links contained in the emails have more powerful timeliness than ordinary links searched in the intranet.

Since the links appearing in the emails are always more important in the enterprise than those links not appearing in the emails, and it is possible to judge importance of the links through an organization position of the senders of the emails, the number of receivers and etc., authority of sorting in the search result presenting page is enhanced. In addition, since emails contain a great deal of up-to-date information, contents repeatedly appearing in the emails contain hot spot information. Search results sorted according to the hot degree have higher authority. Since each user can only acquire information from those emails he/she receives, security of the search is guaranteed.

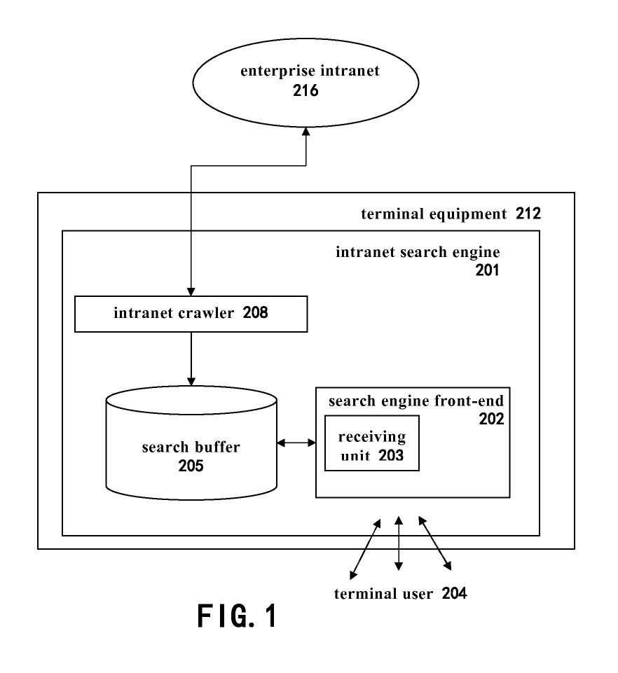

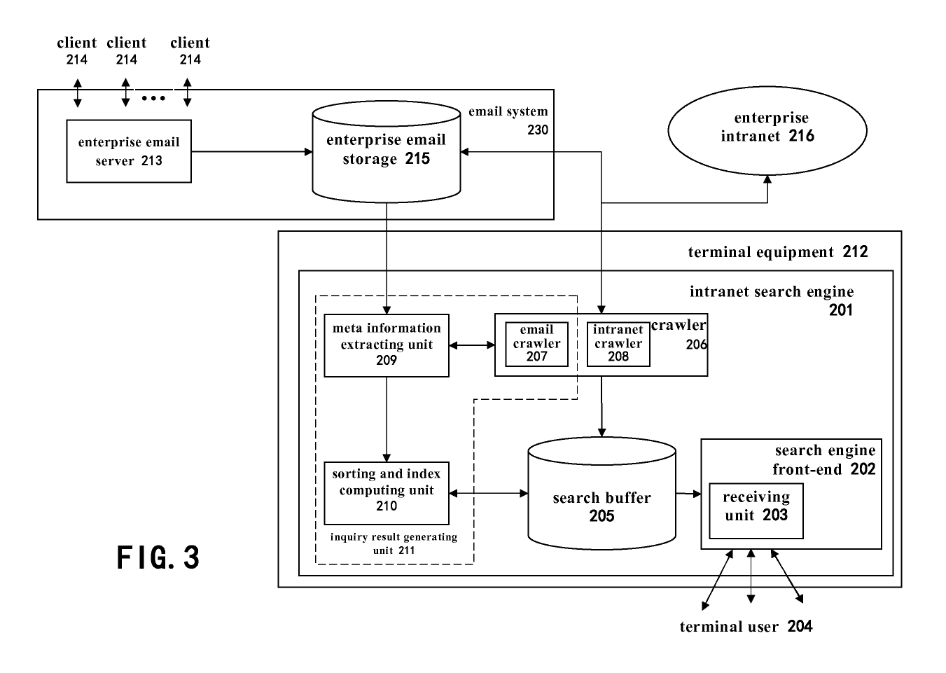

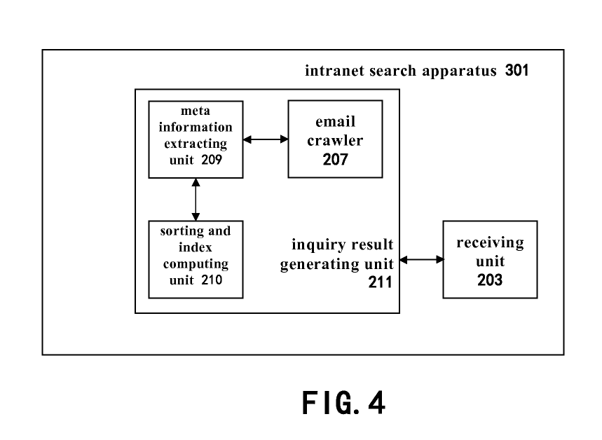

FIG. 3 is a schematic diagram showing an intranet search engine according to an embodiment of the invention and its external environment. FIG. 3 differs from FIG. 1 in that, the intranet search engine 201 not only has an intranet crawler 208 that searches new links periodically on the enterprise intranet 216, but also has an email crawler 207 that searches links appearing in new emails in the email system (the intranet crawler 208 and the email crawler 207 are collectively referred to as a crawler 206). The intranet search engine 201 further includes a meta information extracting unit 209 and a sorting and index computing unit 210. The email crawler 207, meta information extracting unit 209 and sorting and index computing unit 201 constitute an inquiry result generating unit 211. As shown in FIG. 4, the inquiry result generating unit 211 and the receiving unit 203 constitute the intranet search apparatus 301. The intranet search apparatus 301 can appear separately as a product, e.g., a plug-in. By installing the product e.g., plug-in, into the general-purpose intranet search engine shown in FIG. 1, the intranet search engine is enabled to possess the functions of the embodiments of the invention.

The email system 230 includes an enterprise email server 213 and an enterprise email storage 215.

The receiving unit 203 receives an intranet inquiry. In an embodiment, the intranet inquiry is an inquiry with a keyword. Of course, those skilled in the art can make other inquiries without a keyword.

The inquiry result generating unit 211 is configured to, in response to the intranet inquiry, return as a part of search results, a link matching the intranet inquiry in an email in the email system. In the embodiment of keyword inquiry, the inquiry result generating unit 211, in response to the keyword inquiry, returns as a part of search results, a link matching the keyword in an email in the email system to the search result page. The search results further include links matching the intranet inquiry, searched in the intranet.

The email crawler 207 periodically searches links appearing in new emails in the email system and stores them in the search buffer 205. However, the email crawler 207 notifies the meta information extracting unit 209 of the new emails in which links appear, and the meta information extracting unit 209 extracts according to the notification meta information on the new emails in which links appear. The meta information includes e.g., keywords in the title of the email, sender, receiver, email reception time, expiry date contained in the email, and one or more of the keywords in the text of the email. An existing mature semantic analysis technique can be adopted for carrying out the extraction.

The sorting and index computing unit 210 computes indexes for links newly stored in the search buffer (including links in the searched emails and links searched in the intranet) according to the extracted meta information. For the links in the email, indexing is made according to the keywords in the title of the email (and keywords in the text of the email if necessary). For the links searched in the intranet, indexing can be made according to keywords contained in the title, abstract and etc. There are mature techniques for indexing at present.

After the receiving unit 203 receives the intranet inquiry, it issues a request to the search buffer 205. Links matching the intranet inquiry are found in the search buffer 205 based on a match between index made by the sorting and index computing unit 210 and the intranet inquiry. The sorting and index computing unit 210, in response to the intranet inquiry, evaluates the links matching the intranet inquiry according to the extracted meta information, so as to sort the links according to results of the evaluation.

Alternatively, the evaluation on the links matching the intranet inquiry is made based on one or more of the followings: similarity between the search results and the intranet inquiry, importance of the search results, and timeliness of the search results. In case where the intranet inquiry is a keyword inquiry, similarity between the search results and the intranet inquiry is mainly embodied on similarity between the search results and the keyword.

The evaluation on the links matching the intranet inquiry can be made based on other items thinkable by those skilled in the art, so long as the items are reasonable for sorting the links as search results.

As an example of similarity between the search results and the intranet inquiry, similarity between the link whose index contains “year-end sum up report” and the keyword “year-end sum up report” is higher than the similarity between the link whose index contains “year-end report” and the keyword “year-end sum up report”. At present, e.g., on the Internet, there are mature techniques for calculating scores of the search results (i.e., evaluation results) according to similarity and sorting the search results.

Alternatively, the importance of the search results is determined based on one or more of the followings: sources of the links, i.e., whether the links come from emails or from ordinary intranet search; a number of references of the links in the email system; a number of references of the links by other pages in the intranet search; a position of the sender and a number of receivers of the emails referring to the links.

For the sources of the links, a link referred to in the email system is assigned a higher importance than it is referred to by other pages in the intranet search. For the number of references of the link in the email system, the more references of the link in the email system are, the more important it is. For the number of references of the link by other pages in the intranet search, the more references of the link by other pages in the intranet search are, the more important it is. For the link in the email, the higher the position of the email sender referring to the link is, the more important it is. For the link in the email, the more the receivers of the email referring to the link are, the more important it is.

It is provided that, a score of 10 is given if the link appears once in the email, and a score of 1 is given if the link is referred to once by other pages in the intranet search. If the link appears in the email, if the sender of the email is a department manager, a score of 5 is added, if the sender is a general manager, a score of 10 is added, and if the sender is a board chairman, a score of 20 is added. If the link appears in the email, if the number of receivers exceeds 10, a score of 1 is added, if the number exceeds 20, a score of 2 is added, if the number exceeds 30, a score of 3 is added, and so on.

A link A is referred to by two emails and is not referred to by other pages in the intranet search. One of the two emails is sent by the board chairman and has 95 receivers, and the other is sent by the department manager and has 5 receivers, so it is calculated that the importance is (10+20+9)+(10+5)=54.

A link B is referred to by an email and is referred to by other pages in the intranet search 28 times. The sender of the email is an ordinary employee and has 17 receivers. It is calculated that the importance is 10+1+28=39.

A link C is not referred to by emails and is referred to by other pages in the intranet search 25 times. It is calculated that the importance is 25.

There are other manners of calculating the importance and readily occur to those skilled in the art.

Alternatively, for the links in the emails, timeliness of a search result is determined based on a reception time of the email referring to the link, and a valid time in the email referring to the link, wherein the valid time is an important date such as an expiry date and a filing date appearing in the mail. For the link referred to by other pages in the intranet search, timeliness of the search result is set to be a fixed value.

It is provided that, for a link in the email, if the current time−the reception time of the email≦1 minute, then timeliness=40; if the expiry time appearing in the email is earlier than the current time, the score is cancelled and becomes 0; if the current time minus the reception time of the email is longer than 1 minute and is no longer than 1 hour, then timeliness equals 30, but if the expiry time appearing in the email is earlier than the current time, the score is cancelled and becomes 0; if the current time minus the reception time of the email is longer than 1 hour and is no longer than 1 day, then timeliness equals 20, but if the expiry time appearing in the email is earlier than the current time, the score is cancelled and becomes 0; if the current time minus the reception time of the email is longer than 1 day and is no longer than 1 week, then timeliness equals 10, but if the expiry time appearing in the email is earlier than the current time, the score is cancelled and becomes 0; otherwise, timeliness equals 0. For the links found in the intranet search, since the links carry less time information associated therewith, timeliness of the links is set to be 5.

For example, the reception time of the email containing a link D is 17:30:57, 2011 Sep. 28, the expiry time contained in the email is 17:30:57, 2011 Sep. 29, and the current time is 18:06:05, 2011-09-29. The calculated timeliness equals 0.

For example, a link E is a link found in the intranet search. The calculated timeliness equals 5.

If a link appears in a plurality of emails, or not only appears in emails but also is found in the intranet search, timeliness is calculated for each appearance and an average value or a weighted average value is taken.

There are other manners of calculating timeliness and readily occur to those skilled in the art.

In one embodiment, after similarity between the search results and the intranet search, importance of the search results and timeliness of the search results are calculated, an average value or a weighted average value is taken as an evaluation result of the search results. Of course, there are other manners of calculating the evaluation result from similarity, importance and timeliness.

For example, for a link F, similarity between the search result and the keyword is 28, importance of the search result is 16, timeliness of the search result is 10, a weight of similarity is 30%, a weight of importance is 50%, a weight of timeliness is 20%, then the calculated evaluation result is 28×30%+16×50%+10×20%=18.4.

For example, for a link G, similarity between the search result and keyword is 10, importance of the search result is 50, timeliness of the search result is 20, and weights of similarity, importance and timeliness remain unchanged, then the calculated evaluation result is 10×30%+50×50%+20×20%=32.

The searched links in the emails and the links matching the intranet inquiry in the intranet are presented on the search result page in an order based on the evaluation results. According to the above example, the link G is sorted in front of the link F on the search result page. On the search result page, the search results generally are sorted from high to low according to the evaluation results.

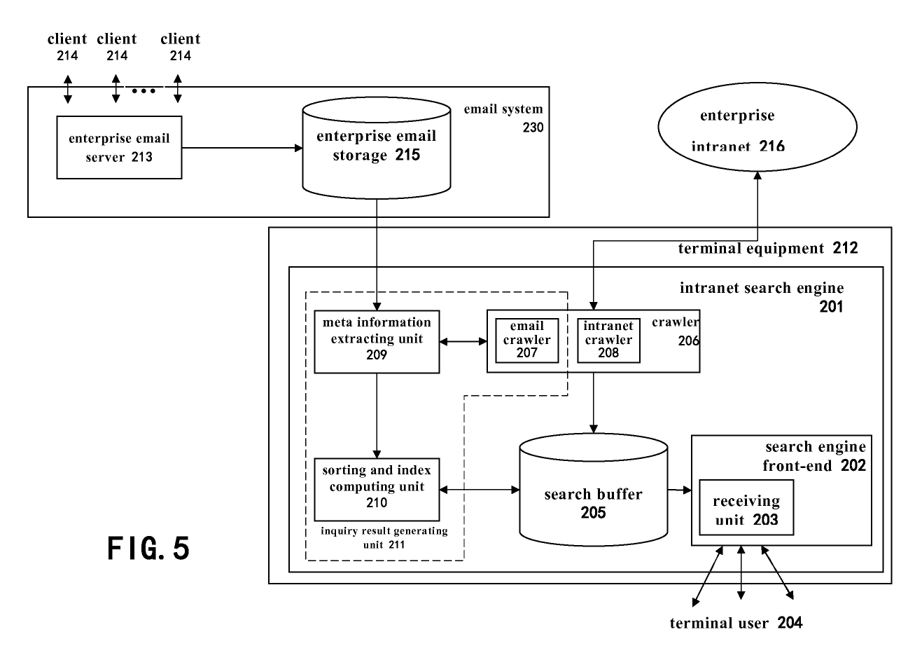

FIG. 5 is a schematic diagram showing an intranet search engine according to another embodiment of the invention and its external environment. FIG. 5 differs from FIG. 4 in that, the email crawler 207 does not directly search in the email system 230. Instead, the meta information extracting unit 209 extracts meta information of all new emails in the email system and sends the links in the new mails having links therein to the email crawler 207. A benefit of this is that a connection between the enterprise email storage 215 and the email crawler 207 is spared, and the email crawler 207 can directly acquire desired links from the meta information extracting unit 209. A shortcoming of this is that, the meta information extracting unit 209 has to extract more meta data, because it not only has to extract meta information of new emails in which the links appear, but also has to extract meta information of new emails in which no links appear, but meta information of new emails in which no links appear is useless.

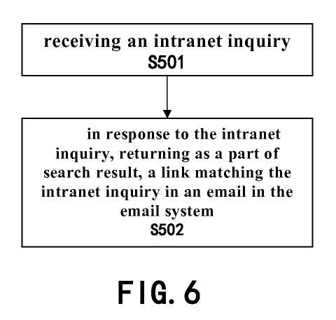

FIG. 6 is a flow chart showing an intranet search method according to an embodiment of the invention. The intranet search method according to an embodiment of the invention includes: a step S501 of receiving an intranet inquiry; and a step S502 of, in response to the intranet inquiry, returning as a part of search results, a link matching the intranet inquiry in an email in the email system.

The flowchart and block diagrams in the Figures illustrate the architecture, functionality, and operation of possible implementations of systems, methods and computer program products according to various embodiments of the present invention. In this regard, each block in the flowchart or block diagrams can represent a module, segment, or portion of code, which includes one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. An intranet search method comprising:
receiving an intranet inquiry; and
in response to the intranet inquiry, returning, as a part of search results, a link matching the intranet inquiry in an email in an email system.

2. The intranet search method according to claim 1, wherein the search results further comprise links matching the intranet inquiry searched in the intranet.

3. The intranet search method according to clam 2, further comprising:
evaluating the links matching the intranet inquiry in emails in the email system and the links matching the intranet inquiry searched in the intranet; and
sorting the links matching the intranet inquiry in emails in the email system and the links matching the intranet inquiry searched in the intranet, according to results of the evaluation.

4. The intranet search method according to claim 3, further comprising:
storing links appearing in new emails in the email system;
extracting meta information of the new mails in which the links appear in the email system; and
computing indexes for the newly stored links according to the extracted meta information, wherein the indexes are compared with the intranet inquiry to determine matches with the intranet inquiry, and evaluation on the links matching the intranet inquiry in emails in the email system is based on the extracted meta information.

5. The intranet search method according to claim 3, wherein the step of evaluating the links matching the intranet inquiry in emails in the email system and the links matching the intranet inquiry searched in the intranet is based on at least one of similarity between the search results and the intranet inquiry, importance of the search results, and timeliness of the search results.

6. The intranet search method according to claim 5, wherein the importance of the search results is determined based on at least one of sources of the links, a number of references of the links in the email system, a number of references of the links by other pages in the intranet search, the position of the sender, and a number of receivers of the emails referring to the links.

7. The intranet search method according to claim 5, wherein for the links in the emails, timeliness of the search result is determined based on a reception time of the email referring to the link, and a valid time in the email referring to the link; and
for the link referred to by other pages in the intranet search, timeliness of the search result is set to be a fixed value.

8. An intranet search apparatus comprising:
a receiving unit configured to receive an intranet inquiry; and
an inquiry result generating unit configured to, in response to the intranet inquiry, return as a part of search results, a link matching the intranet inquiry in an email in an email system.

9. The intranet search apparatus according to claim 8, wherein the search results further comprise links matching the intranet inquiry searched in the intranet.

10. The intranet search apparatus according to clam 9, wherein the inquiry result generating unit comprises:
an email crawler configured to store the links appearing in the new emails in the email system in a search buffer;
a meta information extracting unit configured to extract meta information in the new emails in which the links appear in the email system; and
a sorting and index computing unit configured to compute indexes for the links newly stored in the search buffer according to the extracted meta information, and in response to the intranet inquiry, evaluate the links matching the intranet inquiry according to the extracted meta information to sort the links according to the results of the evaluation, wherein the indexes are compared with the intranet inquiry to determine matches with the intranet inquiry.

11. The intranet search apparatus according to claim 10, wherein after the email crawler stores in the search buffer the links appearing in the new emails in the email system, it notifies the meta information extracting unit of the new emails in which the links appear, and the meta information extracting unit extracts according to the notification meta information in the new emails in which links appear.

12. The intranet search apparatus according to claim 10, wherein the meta information extracting unit extracts meta information from all new emails in the email system, and sends the links appearing in the new emails in which the links appear to the email crawler.

13. The intranet search apparatus according to claim 10, wherein the evaluation on the links matching the intranet inquiry is based on at least one of similarity between the search results and the intranet inquiry, importance of the search results, and timeliness of the search results.

14. The intranet search apparatus according to claim 13, wherein the importance of the search results is determined based on at least one of sources of the links, a number of references of the links in the email system, a number of references of the links by other pages in the intranet search, the position of the sender, and a number of receivers of the emails referring to the links.

15. The intranet search apparatus according to claim 13, wherein for the links in the emails, timeliness of the search result is determined based on a reception time of the email referring to the link, and a valid time in the email referring to the link; and for the link referred to by other pages in the intranet search, timeliness of the search result is set to be a fixed value.

16. An intranet search engine comprising an intranet search apparatus according to claim 8.

17. A terminal equipment comprising an intranet search engine according to claim 16.

18. A computer readable storage medium tangibly embodying a computer readable program code having computer readable instructions which, when implemented, cause a computer to carry out the steps of a method comprising:
receiving an intranet inquiry; and
in response to the intranet inquiry, returning, as a part of search results, a link matching the intranet inquiry in an email in an email system.
